(19) United States
(12) Patent Application Publication
(10) Pub. No.: US 2024/0407323 A1
(43) Pub. Date: Dec. 12, 2024

(54) FULLY AUTOMATIC PET CABIN CLEANING MECHANISM AND PET CABIN WITH THE SAME

(71) Applicant: SHANGHAI XIAOCHONGYOUCANG TECH CO.,LTD, Shanghai (CN)

(72) Inventors: XIAOJIE SHI, Shanghai (CN); ZIYAN SHI, Shanghai (CN)

(21) Appl. No.: 18/332,073

(22) Filed: Jun. 9, 2023

(51) Int. Cl. A01K 1/01

(52) U.S. Cl. CPC A01K 1/0128; A01K 1/011

(57) ABSTRACT

A fully automatic pet cabin cleaning mechanism, comprising guide rails, and a strip-shaped cleaning module that can reciprocate along the guide rails in the pet cabin, a front side of the cleaning module is provided with a feces shoveling board, one end of the feces shoveling board contacts a bottom of the pet cabin, and the cleaning module is provided with a feces collection tank on a front side of an end of a movement path; a bottom of the cleaning module is provided with a cleaning roller brush, which is in contact with the bottom of the pet cabin and can rotate at a high speed. The cleaning mechanism can be arranged in the pet cabin, and through the automatic operation of the equipment, it can automatically complete the daily cleaning of the pet living environment.

### TECHNICAL FIELD

The present application relates to the technical field of pet products, in particular to a fully automatic pet cabin cleaning mechanism and a pet cabin with the same.

### BACKGROUND

With the fast pace of life of modern people, traditional pet cages can no longer meet people's needs for hygiene, feeding, and convenience in daily care. Pet owners are constantly looking for smarter, more convenient, and time-saving pet care products. The easy-to-carry pet cabin came into being.

The pet cabin in the prior art, such as the Chinese patent application “Pet Cabin” with the publication number CN217523537U discloses a pet cabin. A ventilation device is integrated in the pet cabin in this technical solution, which can realize ventilation while keeping the temperature in the cabin stable when going out in cold weather. But when it is in a warm indoor environment, especially when the temperature is high in summer, the existing pet cabin cannot realize automatic cleaning of pet feces, and serious peculiar smell may still be produced because the feces are not cleaned in time. The temperature in the cabin is too high and the smell dissipates slowly, which is not conducive to pets living in the pet cabin. The urine and feces left by pets in the cabin are not efficiently cleaned by manual cleaning. In real life, the feces are often not cleaned up in time. At the same time, due to the large number of electronic components in the existing pet cabin, it is not possible to perform large-scale flushing cleaning and drainage treatment. The cabin body is inconvenient to clean, and dirt is easy to accumulate after long-term use, which seriously affects the pet's own hygiene and living environment.

### SUMMARY

The purpose of the present invention is to provide a fully automatic pet cabin cleaning mechanism and a pet cabin with the same.

In order to achieve the above purpose, the main technical solution of the present invention is to provide a fully automatic pet cabin cleaning mechanism, comprising guide rails, and a strip-shaped cleaning module that is driven by a motor and can reciprocate in the pet cabin along the guide rails, a front side of the cleaning module is provided with a feces shoveling board, one end of the feces shoveling board contacts a bottom of the pet cabin, and the cleaning module is provided with a feces collection tank on a front side of an end of a movement path; a bottom of the cleaning module is provided with a cleaning roller brush, the cleaning roller brush is in contact with the bottom of the pet cabin and can rotate at a high speed.

The pet cabin cleaning mechanism mentioned in this solution can realize fully automatic cleaning, and the main cleaning work is completed through the reciprocating motion of the strip-shaped cleaning module. The forward side of the strip-shaped cleaning module is provided with a feces shoveling board, which can push all the feces on the moving path into the feces collection tank at the end; The cleaning roller brush is arranged on the rear side of the shoveling board and the bottom of the cleaning module. After the shoveling board shovels away the pet feces, it can further clean the bottom of the pet cabin by high-speed rotation.

Preferably, the cleaning roller brush is provided with a cleaning nozzle capable of spraying water.

The cleaning nozzle on the cleaning roller brush can continuously spray water on the cleaning roller brush during the forward movement of the cleaning module, so that the cleaning roller brush can be kept moist, and the sticky feces can also be well removed.

Preferably, the cleaning module is provided with a micro switch at the end of the movement path, when the cleaning module touches the micro switch, the cleaning module can stop moving and start a self-cleaning program; one or more high-pressure nozzles are arranged on a front side of the feces collection tank at the end of the movement path of the cleaning module; a lateral side of the feces collection tank is provided with a sewage outlet, the sewage outlet is connected to a sewage tank, and the feces collection tank is provided with a flushing nozzle on a side opposite to the sewage outlet.

The cleaning module will perform self-cleaning after each cleaning to keep the cleaning module itself clean and prevent secondary pollution. When the self-cleaning program starts, the high-pressure nozzle can flush the dirt on the shoveling board with high-pressure water, and the flushing liquid flows into the feces collection tank, and finally flows into the sewage tank through the sewage outlet for sealing. Since the sewage tank has a cover, it can isolate the smell of feces and keep the air in the pet cabin fresh. When the self-cleaning program is started, the cleaning roller brush rotates at high speed in situ, and the cleaning nozzle continuously sprays water to the cleaning roller brush at the same time, and the cleaning roller brush realizes self-cleaning through friction with the bottom plate and water spraying during high-speed rotation.

Preferably, a starting end of the movement path of the cleaning module is provided with a charging device; the cleaning module is provided with a power supply device, and a rechargeable battery is arranged in the power supply device, when the cleaning module returns to the starting end of the movement path, the power supply device can be docked with the charging device to charge the rechargeable battery.

The motor of the cleaning module provides electric energy through the internal rechargeable battery, and the cleaning module can be connected to the charging device for charging after returning to the initial position after cleaning once. Charging can be wireless charging or wired charging.

Preferably, the cleaning mechanism further comprises a water storage tank, and the water storage tank supplies water for the high-pressure nozzle, the flushing nozzle and the cleaning nozzle.

The cleaning mechanism can be connected to an external water source, or it can be equipped with its own water storage tank. When the pet cabin is taken out, the automatic cleaning function can still be guaranteed not to be affected.

Preferably, the cleaning module is also provided with a small water tank for supplying water to the cleaning nozzle, and the small water tank is provided with a water supply port, the starting end of the movement path of the cleaning module is provided with a water supply port, and the water supply port is connected to the water storage tank through a pipeline and a water pump, when the cleaning module returns to the starting end of the movement path, the water supply port of the small water tank can be docked with the water supply port, and the water supply port supplies the water in the water storage tank to the small water tank through the water pump and the pipeline.

Preferably, the small water tank is provided with a liquid level gauge, and the liquid level gauge is connected with a water valve of the small water tank through an electric signal.

When the cleaning module is reset, the water supply port on the small water tank is docked with the water supply port. When the liquid level gauge detects that the small water tank needs to replenish water, it sends an electrical signal to the water valve of the small water tank, turns on the switch, and the water supply port draws water from the water storage tank through the water pump and pipeline and then injects it into the small water tank. After the water in the small water tank is replenished to the target value, the liquid level gauge sends a closing electric signal to the water valve of the small water tank to stop the water replenishment action.

Preferably, the cleaning module is also provided with a scraper on a side opposite to the feces shoveling board, one side of the scraper contacts the bottom of the pet cabin, and the scraper can clean the bottom of the pet cabin when the cleaning module is reset.

The setting of the scraper enables the cleaning module not only to clean the bottom of the pet cabin when it is moving forward, but also to further scrape and clean the water stains left by the cleaning roller brush when it is reset.

Preferably, the cleaning module is provided with a signal receiver, and the signal receiver can control a start and stop and forward and backward movement of the cleaning module through electrical signals, and can reserve a starting time of the cleaning module.

Signals can be transmitted through APP and other signal terminals, and regular cleaning can be set to complete automatic daily cleaning. When pet owners go out for remote foster care, they can also send signals through APP to clean up the pet cabin automatic cleaning mechanism at any time.

A fully automatic pet cabin cleaning mechanism is provided with any one of the above-mentioned fully automatic pet cabin cleaning mechanisms.

The beneficial effects provided by the present application are: 1) the automatic cleaning of the pet cabin is realized by technical means, thereby solving the technical problem that there are too many electronic components in the pet cabin and the cleaning of pet feces is inconvenient, and prolonging the service life of the pet cabin; 2) the cleaning system can realize intelligent control, which solves the problem of feces cleaning when the pet owner is fostering remotely, and improves the living environment of the pet; 3) It can realize automatic cleaning, which reduces the daily cleaning burden of pet owners.

### BRIEF DESCRIPTION OF DRAWINGS

FIG. 1 is a structural diagram of a fully automatic pet cabin in the first embodiment of the present application.

FIG. 2 is a structural diagram of a fully automatic pet cabin cleaning mechanism in the first embodiment of the present application.

FIG. 3 is an exploded structural diagram of the fully automatic pet cabin cleaning mechanism in the first embodiment of the present application.

Reference signs: 1. Cleaning module, 2. Feces shoveling board, 3. Water storage tank, 4. Sewage tank, 5. Right guide rail, 6. Left guide rail, 7. High-pressure nozzle, 8. Feces collection tank, 9. Flushing nozzle, 10. Small water tank, 11. Cleaning roller brush, 12. Scraper, 13. Rechargeable battery, 14. Power supply device, 15. Water supply port, 16. Water valve of the small water tank.

### DETAILED DESCRIPTION

The technical solutions in the embodiments of the present application will be clearly and completely described below in conjunction with the accompanying drawings in the embodiments of the present application. Apparently, the described embodiments are only some of the embodiments of the present application, but not all of them. All other embodiments obtained by a person skilled in the art based on the embodiments of the present application belong to the protection scope of the present application.

### First Embodiment

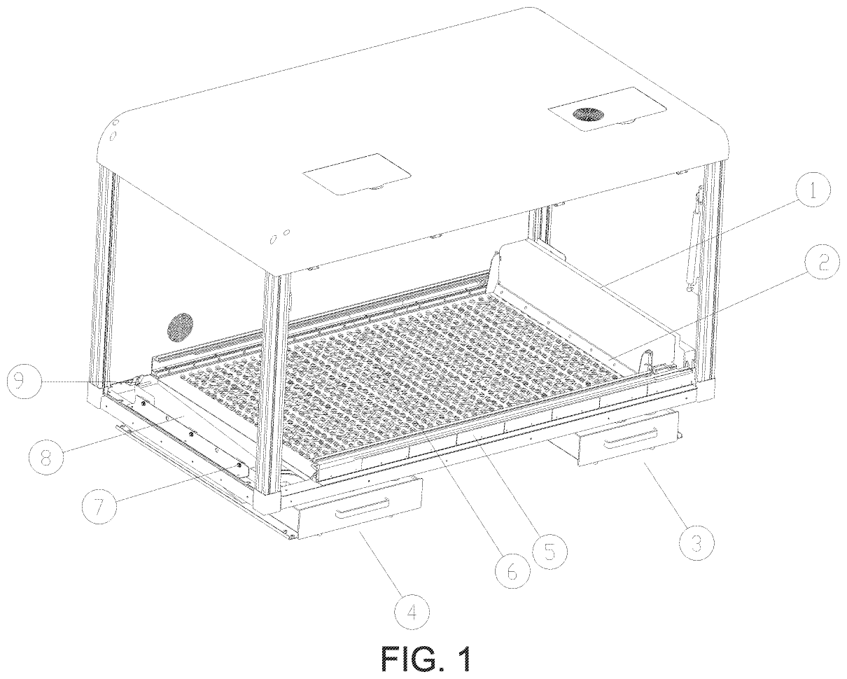

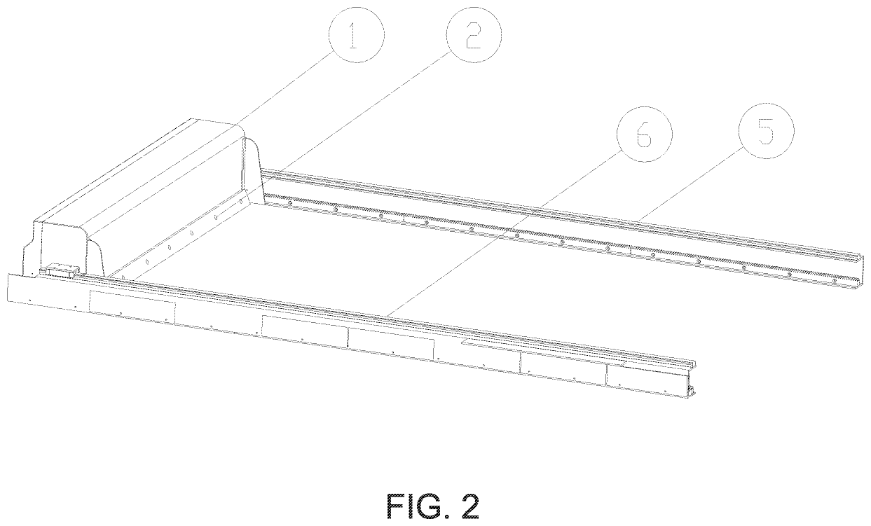

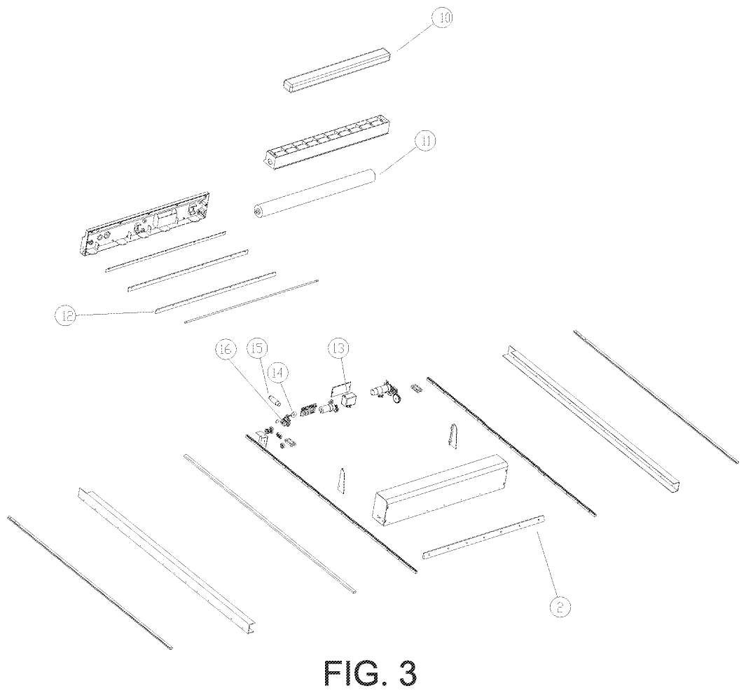

As shown in FIGS. 1-3, this embodiment provides a fully automatic pet cabin. The pet cabin comprises a fully automatic cleaning mechanism. The mechanism comprises a left guide rail 6, a right guide rail 5, and a strip-shaped cleaning module 1 that can reciprocate in the pet cabin along the guide rails driven by a motor, a front side of the cleaning module 1 is provided with a feces shoveling board 2, one end of the feces shoveling board 2 contacts a bottom of the pet cabin, and the cleaning module (1) is provided with a feces collection tank 8 on a front side of an end of a movement path; a bottom of the cleaning module 1 is provided with a cleaning roller brush 11, the cleaning roller brush 11 is in contact with the bottom of the pet cabin and can rotate at a high speed. The cleaning roller brush 11 is provided with a cleaning nozzle that can spray water. The cleaning roller brush 11 advances while rolling at a high speed to clean, and the cleaning nozzle 11 sprays water to the cleaning roller brush 11 to improve cleaning efficiency.

The cleaning module 1 is provided with a micro switch at the end of the movement path, when the cleaning module 1 touches the micro switch, the cleaning module 1 can stop moving and start a self-cleaning program; one or more high-pressure nozzles 7 are arranged on a front side of the feces collection tank 8 at the end of the movement path of the cleaning module 1; a lateral side of the feces collection tank 8 is provided with a sewage outlet, the sewage outlet is connected to a sewage tank 4, and the feces collection tank 8 is provided with a flushing nozzle 9 on a side opposite to the sewage outlet. A starting end of the movement path of the cleaning module 1 is provided with a charging device; the cleaning module 1 is provided with a power supply device 14, and a rechargeable battery 13 is arranged in the power supply device 14, when the cleaning module 1 returns to the starting end of the movement path, the power supply device 14 can be docked with the charging device to charge the rechargeable battery 13. In this embodiment, the charging device adopts a wireless charging device, which can reduce the laying of wires, make water use safer, and pets' activities are more convenient.

The cleaning mechanism further comprises a water storage tank 3, and the water storage tank 3 supplies water for the high-pressure nozzle 7, the flushing nozzle 9 and the cleaning nozzle. The cleaning module 1 is also provided with a small water tank 10 for supplying water to the cleaning nozzle, and the small water tank 10 is provided with a water supply port 15, the starting end of the movement path of the cleaning module 1 is provided with a water supply port, and the water supply port is connected to the water storage tank 3 through a pipeline and a water pump, when the cleaning module 1 returns to the starting end of the movement path, the water supply port 15 of the small water tank 10 can be docked with the water supply port, and the water supply port supplies the water in the water storage tank 10 to the small water tank 10 through the water pump and the pipeline. The small water tank 10 is provided with a liquid level gauge, and the liquid level gauge is connected with a water valve 16 of the small water tank through an electric signal. The cleaning module 1 is also provided with a scraper 12 on a side opposite to the feces shoveling board 2, one side of the scraper 12 contacts the bottom of the pet cabin, and the scraper 12 can clean the bottom of the pet cabin when the cleaning module 1 is reset. The cleaning module 1 is provided with a signal receiver, and the signal receiver can control a start and stop and forward and backward movement of the cleaning module 1 through electrical signals, and can reserve a starting time of the cleaning module 1.

The pet cabin cleaning mechanism mentioned in this solution can realize fully automatic cleaning, and the main cleaning work is completed by the reciprocating motion of the strip-shaped cleaning module 1. The strip-shaped cleaning module 1 is driven by a motor and has a strong power. Its reciprocating motion is fixed by the guide rails to ensure that the cleaning module 1 will not deviate from the movement position when it encounters large pieces of dirt and is subjected to a large force. The forward side of the strip-shaped cleaning module 1 is provided with a feces shoveling board 2, which can push all the feces on the moving path into the feces collection tank 8 at the end; The cleaning roller brush 11 is arranged on the rear side of the shoveling board 2 and the bottom of the cleaning module 1. After the shoveling board shovels away the pet feces, it can further clean the bottom of the pet cabin by high-speed rotation. The cleaning nozzle on the cleaning roller brush 11 can continuously spray water on the cleaning roller brush 11 during the forward movement of the cleaning module 1, so that the cleaning roller brush 11 can be kept moist, and the sticky feces can also be well removed.

The cleaning module 1 will perform self-cleaning after each cleaning to keep the cleaning module 1 itself clean and prevent secondary pollution. When the self-cleaning program starts, the high-pressure nozzle 7 can flush the dirt on the shoveling board 2 with high-pressure water, and the flushing liquid flows into the feces collection tank 8, and finally flows into the sewage tank 4 through the sewage outlet for sealing. Since the sewage tank 4 has a cover, it can isolate the smell of feces and keep the air in the pet cabin fresh. When the self-cleaning program is started, the cleaning roller brush 11 rotates at high speed in situ, and the cleaning nozzle continuously sprays water to the cleaning roller brush 11 at the same time, and the cleaning roller brush 11 realizes self-cleaning through friction with the bottom plate and water spraying during high-speed rotation.

The motor of the cleaning module 2 provides electric energy through the internal rechargeable battery 13, and the cleaning module 1 can be connected to the charging device for charging after returning to the initial position after cleaning once. Charging can be wireless charging or wired charging. The use of wireless charging in this embodiment can simplify the structure of the cabin as much as possible and prevent pets from biting wires and causing electric shocks. The cleaning mechanism can be connected to an external water source, or it can be equipped with its own water storage tank. When the pet cabin is taken out, the automatic cleaning function can still be guaranteed not to be affected. In this embodiment, the design structure of self-contained water storage tank is used. When the cleaning module 1 is reset, the water supply port 15 on the small water tank 10 is docked with the water supply port. When the liquid level gauge detects that the small water tank 10 needs to replenish water, it sends an electrical signal to the water valve 16 of the small water tank, turns on the water valve, and the water supply port draws water from the water storage tank 3 through the water pump and pipeline and then injects it into the small water tank 10. After the water in the small water tank 10 is replenished to the target value, the liquid level gauge sends a closing electric signal to the water valve 16 of the small water tank to stop the water replenishment action. The setting of the scraper 12 enables the cleaning module 1 not only to clean the bottom of the pet cabin when it is moving forward, but also to further scrape and clean the water stains left by the cleaning roller brush 11 when it is reset. Signals can be transmitted through APP and other signal terminals, and regular cleaning can be set to complete automatic daily cleaning. When pet owners go out for remote foster care, they can also send signals through APP to clean up the pet cabin automatic cleaning mechanism at any time. In this embodiment, the cleaning mechanism can be controlled through the mobile phone APP, and when the pet owner goes out for remote foster care, the APP can also transmit a signal to clean up the automatic cleaning mechanism of the pet cabin at any time.

The present application is not limited to the above-mentioned best implementation mode, and anyone can draw other various forms of products under the inspiration of the present application. However, no matter any changes are made in its shape or structure, all technical solutions that are identical or similar to the present application fall within the protection scope of the present application.

What is claimed is:

1. A fully automatic pet cabin cleaning mechanism, comprising guide rails, and a strip-shaped cleaning module (1) that is driven by a motor and can reciprocate in the pet cabin along the guide rails, a front side of the cleaning module (1) is provided with a feces shoveling board (2), one end of the feces shoveling board (2) contacts a bottom of the pet cabin, and the cleaning module (1) is provided with a feces collection tank (8) on a front side of an end of a movement path; a bottom of the cleaning module (1) is provided with a cleaning roller brush (11), the cleaning roller brush (11) is in contact with the bottom of the pet cabin and can rotate at a high speed.

2. The fully automatic pet cabin cleaning mechanism according to claim 1, wherein the cleaning roller brush (11) is provided with a cleaning nozzle capable of spraying water.

3. The fully automatic pet cabin cleaning mechanism according to claim 2, wherein the cleaning module (1) is provided with a micro switch at the end of the movement path, when the cleaning module (1) touches the micro switch, the cleaning module (1) can stop moving and start a self-cleaning program; one or more high-pressure nozzles (7) are arranged on a front side of the feces collection tank (8) at the end of the movement path of the cleaning module (1); a lateral side of the feces collection tank (8) is provided with a sewage outlet, the sewage outlet is connected to a sewage tank (4), and the feces collection tank (8) is provided with a flushing nozzle (9) on a side opposite to the sewage outlet.

4. The fully automatic pet cabin cleaning mechanism according to claim 1, wherein a starting end of the movement path of the cleaning module (1) is provided with a charging device; the cleaning module (1) is provided with a power supply device (14), and a rechargeable battery (13) is arranged in the power supply device (14), when the cleaning module (1) returns to the starting end of the movement path, the power supply device (14) can be docked with the charging device to charge the rechargeable battery (13).

5. The fully automatic pet cabin cleaning mechanism according to claim 3, wherein the cleaning mechanism further comprises a water storage tank (3), and the water storage tank (3) supplies water for the high-pressure nozzle (7), the flushing nozzle (9) and the cleaning nozzle.

6. The fully automatic pet cabin cleaning mechanism according to claim 5, wherein the cleaning module (1) is also provided with a small water tank (10) for supplying water to the cleaning nozzle, and the small water tank (10) is provided with a water supply port (15), the starting end of the movement path of the cleaning module (1) is provided with a water supply port, and the water supply port is connected to the water storage tank (3) through a pipeline and a water pump, when the cleaning module (1) returns to the starting end of the movement path, the water supply port (15) of the small water tank (10) can be docked with the water supply port, and the water supply port supplies the water in the water storage tank (3) to the small water tank (10) through the water pump and the pipeline.

7. The fully automatic pet cabin cleaning mechanism according to claim 6, wherein the small water tank (10) is provided with a liquid level gauge, and the liquid level gauge is connected with a water valve (16) of the small water tank through an electric signal.

8. The fully automatic pet cabin cleaning mechanism according to claim 1, wherein the cleaning module (1) is also provided with a scraper (12) on a side opposite to the feces shoveling board (2), one side of the scraper (12) contacts the bottom of the pet cabin, and the scraper (12) can clean the bottom of the pet cabin when the cleaning module (1) is reset.

9. The fully automatic pet cabin cleaning mechanism according to claim 1, wherein the cleaning module (1) is provided with a signal receiver, and the signal receiver can control a start and stop and forward and backward movement of the cleaning module (1) through electrical signals, and can reserve a starting time of the cleaning module (1).

10. A fully automatic cleaning pet cabin, comprising the fully automatic pet cabin cleaning mechanism according to claim 1.
